(19) United States
(12) Patent Application Publication
(10) Pub. No.: US 2025/0332067 A1
(43) Pub. Date: Oct. 30, 2025

(54) MAGNETIC CUP ASSEMBLY

(71) Applicant: Northstar Medical Technologies, LLC, Beloit, WI (US)

(72) Inventors: Dustin Wanden ZITTLOW, Watertown, WI (US); Jakob Edwin BAUMEISTER, Janesville, WI (US); Spencer Douglas ORTYN, Grafton, WI (US)

(73) Assignee: Northstar Medical Technologies, LLC, Beloit, WI (US)

(21) Appl. No.: 19/184,189

(22) Filed: Apr. 21, 2025

Related U.S. Application Data
(60) Provisional application No. 63/639,951, filed on Apr. 29, 2024.

(51) Int. Cl. A61J 1/14; B33Y 80/00

(52) U.S. Cl. CPC A61J 1/1412; B33Y 80/00

(57) ABSTRACT

A magnetic cup includes a first cup portion including a first magnet and a second cup portion including a second magnet. A target capsule is placed between the first cup portion and the second cup portion. The target capsule is sealed with a first seal. The magnetic cup provides a second seal formed from a magnetic force between the first magnet and the second magnet. Further provided is a tool designed to assist a user for opening the magnetic cup. The tool includes a first arm including a third magnet designed to attract the first magnet through a second magnetic force greater than the first magnetic force, and a second arm including a fourth magnet designed to attract the second magnet through a third magnetic force greater than the first magnetic force.

### CROSS-REFERENCE TO RELATED APPLICATIONS

This application claims priority to U.S. provisional application Ser. No. 63/639,951, filed on Apr. 29, 2024.

### TECHNICAL FIELD

The present disclosure generally relates to a magnetic cup assembly for use with a target capsule for the production of a desired product radioisotope. Further, the present disclosure relates to a system and method for opening the magnetic cup assembly.

### BACKGROUND

Radioisotopes, such as those used in nuclear medicine, can be produced using a target material. The target material is irradiated in a nuclear reactor or particle accelerator. The target material is typically encapsulated in a protective casing, sometimes referred to as a target capsule, to prevent contamination of the target material and for ease of handling. The target capsule is placed inside a target irradiation vault and irradiated with an electron beam. The target material inside the target capsule absorbs neutrons from the electron beam, which leads to nuclear reactions that result in the production of a desired product radioisotope. Afterwards, the target capsule is transferred to a further chamber, sometimes referred to as a hot cell, for chemical processing.

The target capsule typically has at least two parts, including a top (e.g., a lid) and a bottom (e.g., a base), which can be coupled or sealed together. For example, the top and the bottom of the capsule can be welded shut. Welding the target capsule shut is an effective method to prevent leakage or exposure of the target material during transportation and irradiation of the target capsule.

After irradiation, the target capsule is removed from the target irradiation vault and processed to separate the desired product radioisotope from the capsule and other radioactive and non-radioactive isotopes, often referred to as stable isotopes, produced during the irradiation process. The separation process can include chemical separation techniques such as solvent extraction, ion exchange, and precipitation to isolate the desired product radioisotope. For example, the irradiated target capsule can be placed in a dissolution assembly including a dissolution vessel designed to contain the capsule and facilitate recovery of the desired product radioisotope. Thus, to recover the desired product radioisotope, the welded seal on the capsule must be broken to access the materials inside the target capsule.

However, once the target capsule seal is broken, caution must be observed to ensure that the target capsule lid does not separate from the target capsule base until the capsule is sealed in the dissolution vessel. If the top and bottom of the target capsule separate from each other, the desired product radioisotope can be contaminated, and a person handling the unsealed target capsule risks exposure to radioactive materials.

Further, even if the unsealed target capsule is safely transported to the dissolution vessel, additional tools may be needed to orient and open the unsealed target capsule in the dissolution vessel. For example, the top and bottom of the unsealed target capsule must be completely separated and oriented in the dissolution vessel so that the desired product radioisotope can drain from the opened target capsule. Accordingly, the dissolution vessel may need to be opened to insert a tool into the vessel to open and/or orient the target capsule.

However, opening the dissolution vessel can negatively impact the recovery of the desired product radioisotope because static cling can cause the desired product radioisotope to adhere to the surface of the target capsule, making recovery of the desired product radioisotope difficult. Further, opening the dissolution vessel with the unsealed and/or opened target capsule can result in radioactive material escaping the vessel and contaminating other equipment, the hot cell, and a human operator.

Once the target capsule is opened, the dissolution vessel can be filled with a dissolution solution (e.g., water) to facilitate the separation of the desired product radioisotope from the target capsule. It can be beneficial to agitate the dissolution solution and the target capsule contained in the dissolution vessel during the separation process to ensure a high yield of the desired product radioisotope. Some common instruments for agitating the dissolution solution and target capsule can include sonicating rods or stir bars. However, these instruments must be disposed of as radioactive waste afterward.

Accordingly, a need exists for a system and a method for safely transporting an irradiated target material within a target capsule to a dissolution assembly while minimizing the loss of the radioactive material within the target capsule and minimizing contamination of a desired product radioisotope. Further, a need exists for a system and a method for opening the target capsule in a dissolution assembly without having to physically contact the target capsule with a tool.

### BRIEF SUMMARY

An aspect of this disclosure pertains to a magnetic cup for use with a target capsule. The magnetic cup includes a first cup portion including a first recess designed to retain a first magnet and at least a first portion of the target capsule, and a second cup portion including a second recess designed to retain a second magnet and at least a second portion of the target capsule, wherein the first magnet and the second magnet are attracted to each other through a magnetic force, thereby causing the first cup portion and the second cup portion to be drawn towards each other thereby forming the magnetic cup.

In one aspect, the first cup portion and the second cup portion are composed of a metal.

In another aspect, the first cup portion and the second cup portion are composed of a plastic.

In some instances, the first cup portion and the second cup portion are made through a 3D printing process.

In another implementation, the first magnet is secured to the first cup portion and the second magnet is secured to the second cup portion through one or more catches.

In yet another example, the first magnet is secured to the first cup portion and the second magnet is secured to the second cup portion via an adhesive.

In some instances, the target capsule includes a welded seal that is not covered by the magnetic cup.

In another aspect, the target capsule is designed to contain a target material for irradiation.

The disclosure further pertains to a magnetic cup assembly for use with a target assembly. The magnetic cup assembly includes a magnetic cup comprising a first cup portion including a first magnet, and a second cup portion including a second magnet, wherein the first magnet and the second magnet are attracted to each other through a first magnetic force, thereby causing the first cup portion and the second cup portion to be drawn towards each other and at least partially surround the target capsule. The magnetic cup assembly further includes a tool designed to assist a user in opening the magnetic cup. The tool comprises a first arm including a third magnet designed to attract the first magnet through a second magnetic force greater than the first magnetic force, and a second arm including a fourth magnet designed to attract the second magnet through a third magnetic force greater than the first magnetic force.

In some aspects, the tool is designed to open the magnetic cup by overcoming the first magnetic force between the first cup portion and the second cup portion when the magnetic cup is placed in a region between the first arm and the second arm of the tool.

In another instance, the tool further comprises a connection member. The first arm is connected to and extends outwardly from a first portion of the connection member, and the second arm is connected to and extends outwardly from a second portion of the connection member, opposite of the first portion.

In yet another case, the connection member is provided in the shape of a ring designed to engage with a syringe included in a dissolution assembly.

In still another implementation, the tool is designed orient the magnetic cup in a sideways position when the magnetic cup is placed in the syringe.

In some instances, the magnetic cup assembly further comprises a manipulator device designed to move the tool around the syringe, thereby moving the magnetic cup.

In some aspects, an interior chamber of the target capsule can be accessed when the magnetic cup is opened.

The disclosure further pertains to a method of securing a target capsule in a closed position. The method comprises the steps of providing the target capsule, comprising a first capsule portion including a first body and a first rim extending outwardly from the first body, and a second capsule portion including a second body and a second rim extending outwardly from the second body. The method includes creating a first seal between the first rim and the second rim, providing a magnetic cup, comprising a first cup portion including a first recess designed to retain a first magnet and the first body of the target capsule, and a second cup portion including a second recess designed to retain a second magnet and the second body of the target capsule, and a second seal between the first cup portion and the second cup portion.

In some instances, the first seal is created by welding the first rim to the second rim.

In other instances, the first seal can be broken without breaking the second seal.

In some aspects, the second seal is created by a drawing the first cup portion towards the second cup portion through a magnetic force between the first magnet and the second magnet.

In yet another implementation, the first seal is created prior to creating the second seal.

### BRIEF DESCRIPTION OF THE DRAWINGS

In the drawings forming a part of this disclosure:

FIG. 1 is front isometric view illustrating an exemplary target capsule;

FIG. 2 is a top isometric view of the target capsule of FIG. 1;

FIG. 3 is a side elevation cross-sectional view of the target capsule of FIG. 1;

FIG. 4 is an exploded view of a magnetic cup for use with the target capsule of FIG. 1, in accordance with an exemplary embodiment of the invention;

FIG. 5 is a partial exploded view of the magnetic cup of FIG. 4, illustrating some parts of the magnetic cup assembled;

FIG. 6 is a front elevation cross-sectional view of the magnetic cup of FIG. 4, illustrating some of the internal components of the magnetic cup;

FIG. 7 is a partial exploded view of a magnetic cup, illustrating a top cup portion of the magnetic cup detached from the magnetic cup;

FIG. 8 is a front isometric cross-sectional view of the magnetic cup of FIG. 7, illustrating some of the internal components of the magnetic cup;

FIG. 9 is a front elevation cross-sectional view of a magnetic cup assembly of in accordance with an exemplary embodiment of the invention, illustrating some of the internal components of the magnetic cup assembly;

FIG. 10 is a front elevation view of the magnetic cup assembly of FIG. 1 within a dissolution syringe assembly;

FIG. 11 is a partial zoomed in view of FIG. 10 illustrating the magnetic cup assembly of FIG. 1 within the dissolution syringe assembly;

FIG. 12 is a top isometric view of a 3D-printed magnetic cup assembly according to an exemplary embodiment of the invention;

FIG. 13 is a top isometric view of the 3D printed magnetic cup assembly of FIG. 12 with a top cup portion removed;

FIG. 14 is a top isometric view of a target capsule included in the 3D printed magnetic cup assembly of FIG. 12;

FIG. 15 is a partial front elevation view of the 3D printed magnetic cup assembly of FIG. 12 within a dissolution syringe assembly according to an exemplary embodiment of the invention;

FIG. 16 is first side isometric view of the 3D printed magnetic cup assembly of FIG. 12 and an opening tool engaged with the dissolution syringe assembly of FIG. 15, according to an exemplary embodiment of the invention; and

FIG. 17 is a second side isometric view of the 3D printed magnetic cup assembly of FIG. 12 and the opening tool of FIG. 16 engaged with the dissolution syringe assembly of FIG. 15.

Before explaining the disclosed embodiment of the present invention in detail, it is to be understood that the invention is not limited in its application to the details of the particular arrangement shown since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and can be practiced or carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof, as well as additional items.

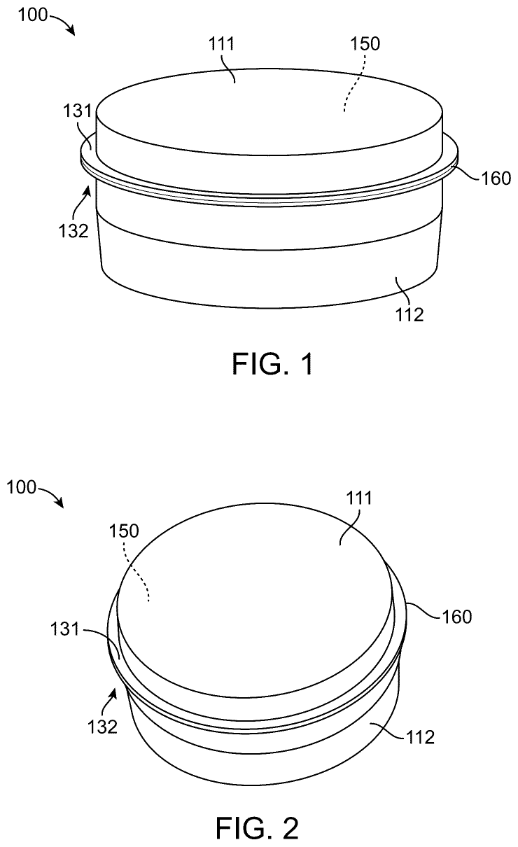

FIGS. 1-3 illustrate various views of a target capsule 100. As shown, the target capsule 100 can be provided in the form of a cylinder. However, the target capsule 100 can be provided in other various shapes, such as a rectangle or cube. In some instances, the target capsule 100 can be approximately the same diameter or width as an American quarter (e.g., about 0.8 to about 1.0 inches).

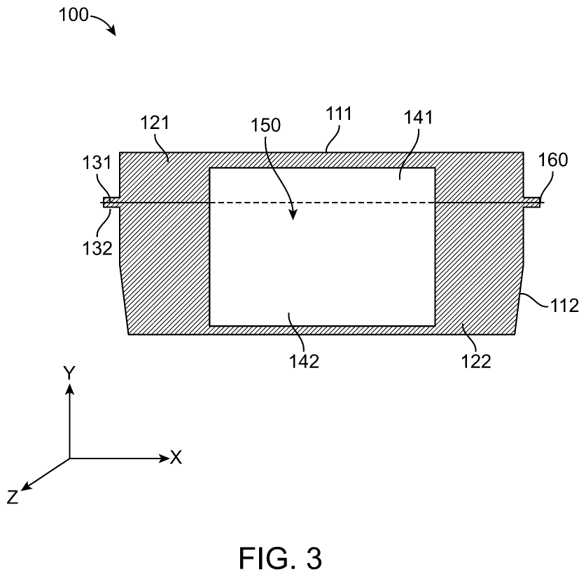

The target capsule 100 includes a first capsule portion 111 and a second capsule portion 112. The structures of the first capsule portion 111 and the second capsule portion 112 can be substantially similar. Thus, although the second capsule portion 112 is illustrated as being larger (e.g., having a greater height or depth in the y-direction as shown in FIG. 3), this is not to be considered limiting. In some instances, the first capsule portion 111, and the second capsule portion 112, have a substantially similar height in the y-direction.

The first capsule portion 111 includes a first body 121 and a first rim 131 extending outwardly from the first body 121. The second capsule portion 112 includes a second body 122 and a second rim 132 extending outwardly from the second body 122.

Further, the first capsule portion 111 includes a first cavity 141 carved out of or formed within the first body 121. Similarly, the second capsule portion 112 includes a second cavity 142 carved out of or formed within the second body 122. The first cavity 141 and the second cavity 142 can be substantially similar (e.g., have a substantially similar radius or width in the x-direction). Thus, when the first capsule portion 111 is placed adjacent to the second capsule portion 112, an enclosed interior chamber 150 is formed from the first cavity 141 and the second cavity 142.

To seal the interior chamber 150, an outside surface of each of the first rim 131 and the second rim 132 can be sealed to form a first seal 160. In some examples, the first seal 160 is formed by welding at least a portion of the first rim 131 and the second rim 132 together. Before sealing the first rim 131 and second rim 132, a target material can be placed in the interior chamber 150. The target material can be a radioisotope that is used as a starting material for a desired product radioisotope.

Illustrative target material radioisotopes in demand include rhenium-188 (¹⁸⁸Re), which can be used for radiopharmaceuticals to diagnose and treat malignant tumors, bone metastases, and rheumatoid arthritis. Gallium-68 (⁶⁸Ga) which can be used for positron emission tomography (PET) scans. Actinium-225 (²²⁵Ac) is primarily used in cancer therapy, such as in targeted alpha therapy (TAT) to treat prostate, brain, and neuroendocrine cancers. Bismuth-213 (²³¹Bi) is a candidate alpha emitter proposed for use in cancer therapy.

Each of the above-named isotopes is the product of the radioactive decay of a parental isotope referred to herein as a mother isotope, with the enumerated decay-product isotope being referred to as a daughter isotope. Thus, ¹⁸⁸Re is the daughter of tungsten-188 (¹⁸⁸W), ⁶⁸Ga is the daughter of germanium-68 (⁶⁸Ge), ²²⁵Ac is the daughter of radium-225 (²²⁵Ra), and ²¹³Bi is the daughter of ²²⁵Ac. It is to be understood that each of the mother isotopes is a daughter of a higher atomic weight mother isotope. However, as used herein, the isotope used as the immediately prior starting material is the named mother, and the desired product isotope is referred to as the daughter isotope.

Because most of the medically useful radioisotopes are produced by means of a human-induced bombardment of a parental isotope via a high-energy nuclear device such as a cyclotron, synchrotron, electron beam, or similar device, the target material is often contained within a container, such as the target capsule 100, that can be placed within the nuclear device. After irradiation, the target capsule 100 is removed from the nuclear device so that the product radioisotope can be recovered.

In the case of the target capsule 100, to recover the product radioisotope, the first seal 160 must be broken so the interior chamber 150, which contains the product radioisotope, can be accessed. As discussed herein, breaking the first seal 160 can be hazardous to a person handling the target capsule 100 due to possible exposure to radioactive material. Moreover, opening the first seal 160 creates the potential for contaminants to taint the desired product radioisotope.

However, the first seal 160 must be broken before loading the target capsule 100 within a dissolution assembly because the dissolution assembly is a sealed environment designed to recover the desired product radioisotope. Thus, there is a need for a system and a method for securing the first capsule portion 111 and the second capsule portion 112 together, even after the first seal 160 has been broken. Further, there is a need for a system and a method for separating the first capsule portion 111 and the second capsule portion 112 once the target capsule 100 is enclosed within a dissolution assembly.

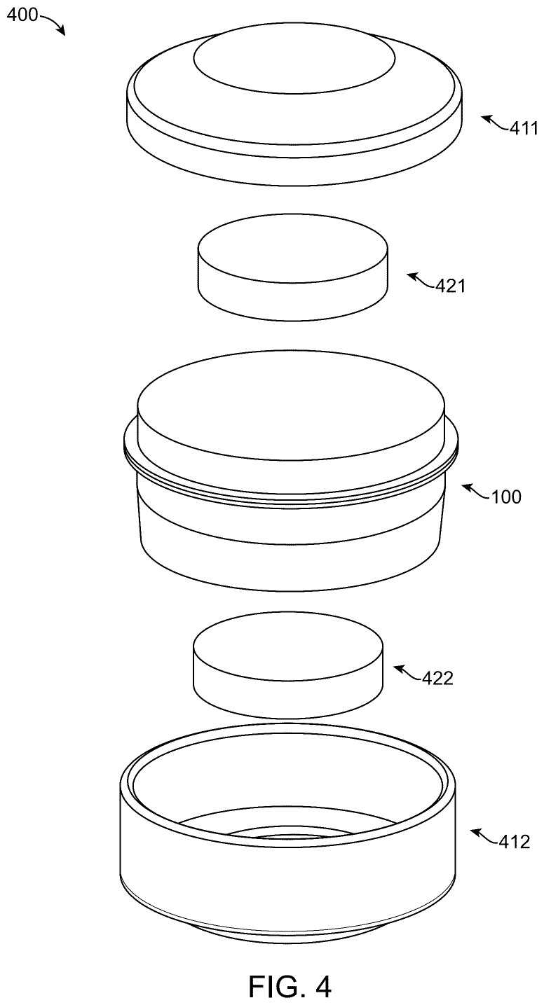

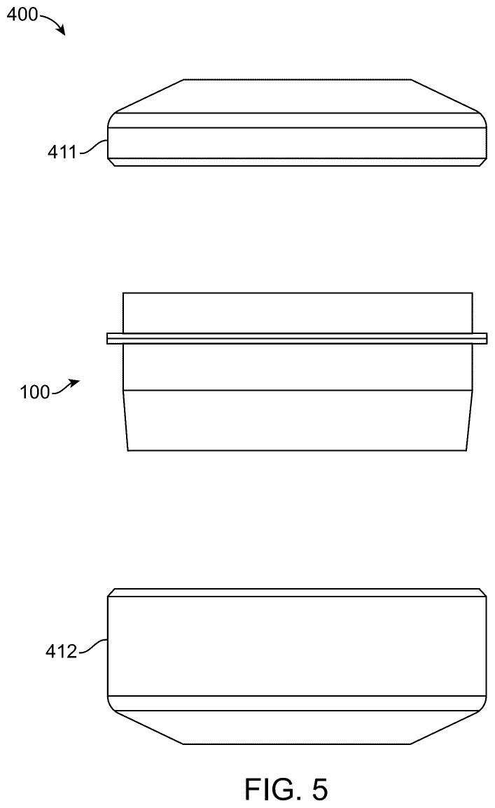

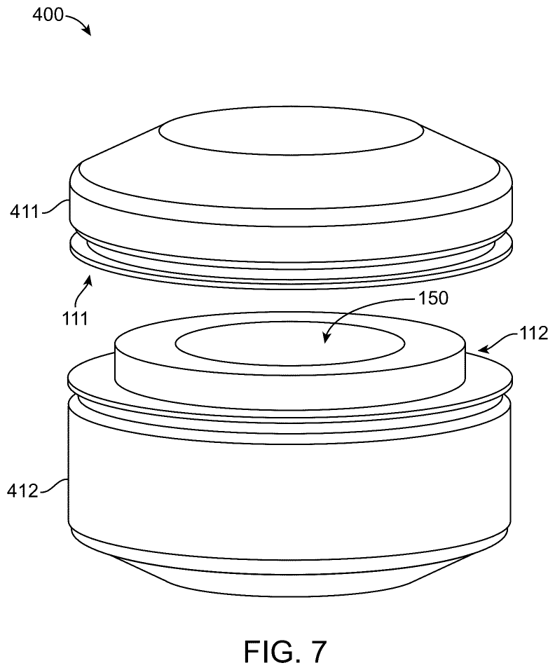

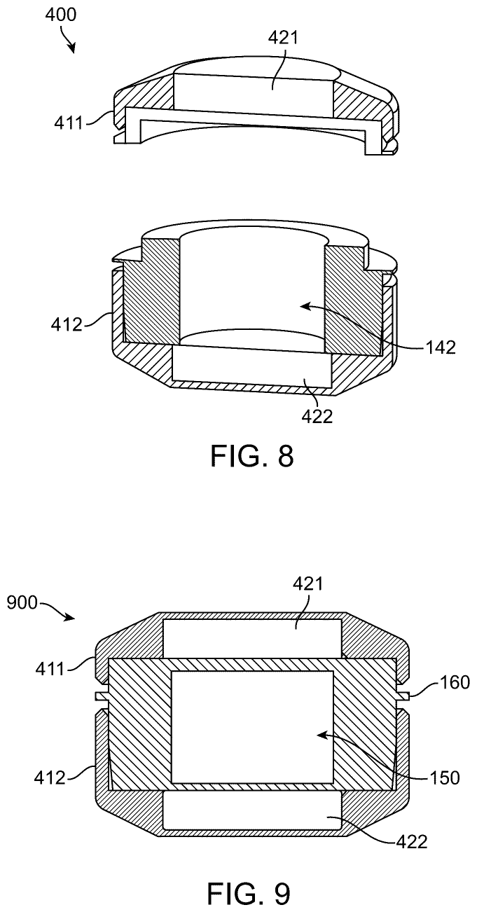

Accordingly, FIGS. 4-8 illustrate various views of an exemplary magnetic cup 400 for use with a target capsule 100. As discussed in more detail herein, the magnetic cup 400 improves the safety of handling the target capsule 100 because the magnetic cup 400 is designed to ensure the target capsule 100 remains closed when the first seal 160 of the target capsule 100 is broken. Thus, the magnetic cup 400 can reduce the risk of exposure to radioactive materials contained within the target capsule 100 and prevent contaminants from entering the target capsule 100 before the desired product radioisotope can be recovered. Further, the magnetic cup 400 helps facilitate efficient recovery of a product radioisotope within the target capsule 100 because the magnetic cup 400 is designed to be opened with a tool that can be used without opening the dissolution vessel.

The magnetic cup 400 includes a first cup portion 411, a second cup portion 412, a first magnet 421, and a second magnet 422. In some instances, the first cup portion 411 and the second cup portion 412 can be constructed from the same materials. In other instances, the first cup portion 411 and the second cup portion 412 can be constructed from different materials.

Non-limiting examples of cup materials for the first cup portion 411 and the second cup portion 412 include plastic such as Polyether ether ketone (PEEK), Polyvinyl Chloride (PVC), polyethylene, polypropylene, polylactic acid (PLA), acrylonitrile butadiene styrene (ABS), polyethylene terephthalate glycol (PETG), polycarbonate (PC), nylon (polyamide), and polyvinyl alcohol (PVA). In a particular example, PEEK may be a preferred material because of its thermal resistance, chemical resistance, and durability. In another particular example, PVC may be a preferred material because of its low cost and durability. Additional non-limiting examples for the first cup portion 411 and the second cup portion 412, include metals such as aluminum, copper, stainless steel, titanium, tantalum, and gold.

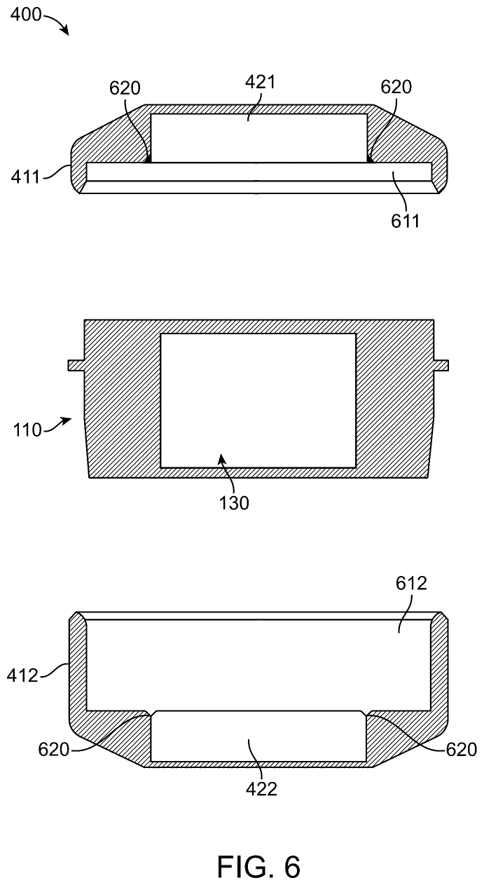

As shown best in FIG. 6, the first cup portion 411 includes a first recess 611 designed to retain the first magnet 421 and at least a first portion of the target capsule 100 (e.g., at least a portion of the first body 121 of the first capsule portion 111). Similarly, the second cup portion 412 includes a second recess 612 designed to retain the second magnet 422 and at least a second portion of the target capsule 100 (e.g., at least a portion of the second body 122 of the second capsule portion 112. Each of the first recess 611 and the second recess 612, can be sized such that the first capsule portion 111 and the second capsule portion 112 are secured within the respective recesses through a friction fit.

In some embodiments, the first magnet 421 and the second magnet 422 are snapably secured within and/or press-fit into the first cup portion 411 and the second cup portion 412, respectively, to prevent the first magnet 421 and the second magnet 422 from falling out of the respective cup portions. Additionally, in some instances, the first cup portion 411 and/or the second cup portion 412 define lead-in features 620 (e.g., a chamfer, radius, fillet, etc.) to aid insertion of the first magnet 421 and the second magnet 422 into the first cup portion 411 and the second cup portion 412, respectively. In some instances, the first magnet 421 and the second magnet 422 can be secured within the first cup portion 411 and the second cup portion 412 with a glue applied to a surface of each magnet that contacts an adjacent surface of each respective cup portion.

The first magnet 421, and the second magnet 422, are oriented such that their respective poles are attracted to each other. Thus, the first magnet 421 and the second magnet 422 cause the first cup portion 411 and the second cup portion 412 to be drawn together, thereby forming the magnetic cup 400. Accordingly, when the target capsule 100 is placed in the magnetic cup 400 (e.g., within the first recess 611 and the second recess 612), the first magnet 421 and the second magnet 422 cause the first cup portion 411 and the second cup portion 412 to apply pressure to the target capsule 100, thereby forming a second seal around the target capsule 100. In other words, the magnetic cup 400 is “closed” when the second seal is formed. The target capsule 100 and the magnetic cup 400 can be collectively referred to as a magnetic cup assembly 900 when both the first seal 160 and the second seal are formed.

A benefit of the second seal (e.g., the magnetic force between the first magnet 421 and the second magnet 422) is that the second seal can be formed without having to entirely enclose the target capsule 100. For instance, as shown best in FIG. 9, the first seal 160 can be exposed even when the magnetic cup 400 is closed. Thus, the first seal 160 can be broken without breaking the second seal.

For example, in a method for producing a desired product radioisotope, a target material can be placed in the interior chamber 130 of the target capsule 100. The interior chamber 130 can be sealed via the first seal 160. The target capsule 100 can then be placed within the magnetic cup 400, and the second seal can be formed by allowing the first cup portion 411 and the second cup portion 412 to be drawn together through the magnetic force of the first magnet 421 and the second magnet 422.

The sealed target capsule 100 can be placed in a nuclear device and irradiated to produce the desired product radioisotope. The sealed target capsule 100 is then removed from the nuclear device to recover the desired product radioisotope. Further, the irradiated and sealed target capsule 100 is assembled and further sealed into the magnetic cup 400, thus forming the magnetic cup assembly 900.

As discussed herein, the first seal 160 is broken to recover the desired product radioisotope. However, to reduce the risk of radioactive exposure and limit contamination of the desired product radioisotope, the second seal formed by the magnetic cup 400 is not broken.

The magnetic cup assembly 900 can then be placed in a dissolution assembly designed to recover the desired product radioisotope. However, the second seal also needs to be broken to recover the desired product radioisotope. Accordingly, a tool is needed to break the second seal.

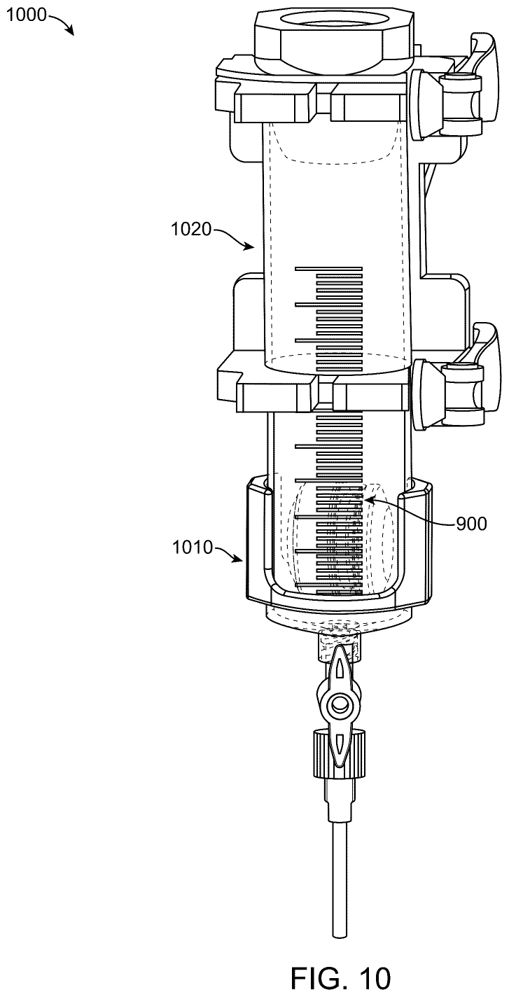

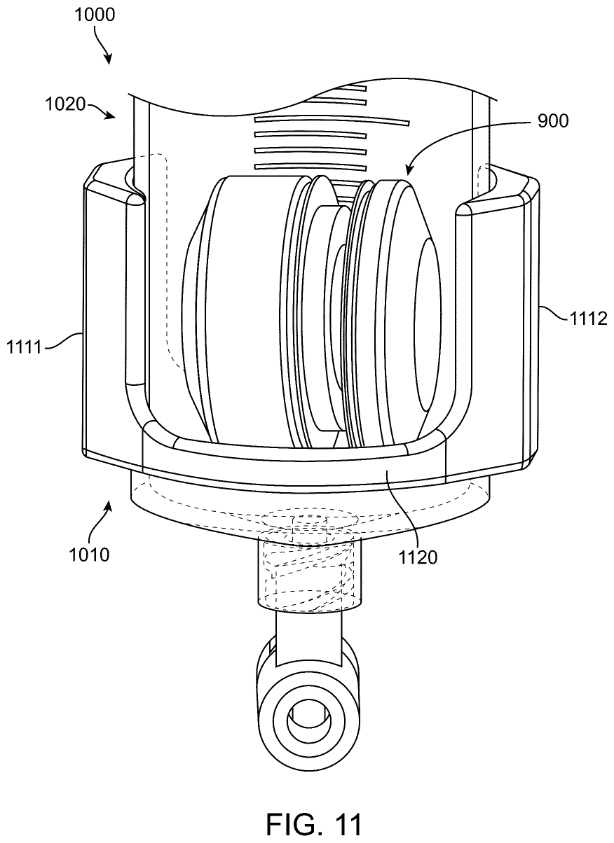

FIGS. 10 and 11 illustrate various views of a portion of a dissolution assembly 1000 and a tool 1010 designed to work with the dissolution assembly 1000 and help facilitate recovery of a desired product radioisotope. The dissolution assembly 1000 can include a syringe 1020 designed to hold the magnetic cup assembly 900. To recover the desired product radioisotope, the second seal of the magnetic cup 400 must be broken. Further, it is ideal to orient the magnetic cup assembly 900 in a sideways position so that the contents of the target capsule 100 can easily drain from the interior chamber 150. Accordingly, the tool 1010 can be designed to orient the magnetic cup assembly 900 and break the second seal of the magnetic cup 400 without having to open the dissolution assembly 1000.

As shown best in FIG. 11, the tool 1010 includes a first arm 1111, including a third magnet, and a second arm 1112, including a fourth magnet. The first arm 1111 and the second arm 1112 can be attached to opposite sides of a connection member 1120. In particular, the first arm 1111 can attach to and extend outwardly from a first portion of the connection member 1120, and the second arm 1112 can attach to and extend outwardly from a second portion of the connection member 1120.

The connection member 1120 can be provided in the form of a ring-shaped structure that can encircle or engage with the syringe 1020. Thus, the position of the tool 1010 along the length of the syringe 1020 can be adjusted. Further, the tool 1010 can be rotated around the syringe 1020. The ability to move the tool 1010 can be beneficial during a recovery process because the movement of the tool 1010 can help reposition the magnetic cup assembly 900.

For example, during a recovery process, the magnetic cup assembly 900 can be dropped in the syringe 1020 and the syringe 1020 can be sealed. Because the tool 1010 can properly orient the magnetic cup assembly 900 and the second seal is still in place, a mechanical device can transport the magnetic cup assembly 900, further reducing the risk of radioactive exposure from the magnetic cup assembly 900.

The tool 1010 can be placed around the syringe 1020 prior to or after the magnetic cup assembly 900 is loaded into the syringe 1020. When the tool 1010 is placed around the syringe 1020, the first arm 1111 and the second arm 1112 can extend along a lateral outside wall of the syringe 1020. Thus, the magnetic cup assembly 900, contained within the syringe 1020, can be at least partially surrounded by the tool 1010. In other words, the magnetic cup assembly 900 can be positioned within a portion of the syringe 1020 where the first arm 1111 and the second arm 1112 are proximate to the magnetic cup assembly 900.

Once the magnetic cup assembly 900 is positioned between the first arm 1111 and the second arm 1112 of the tool 1010, the third magnet and the fourth magnet of the tool 1010 cause the magnetic cup assembly 900 to orient itself on its side. Further, the tool 1010 can break the second seal of the magnetic cup 400. The tool 1010 breaks the second seal because an attractive magnetic force between the first magnet 421 of the magnetic cup 400 and the third magnet of the first arm 1111 of the tool 1010 is stronger than the attractive force between the first magnet 421 and the second magnet 422 of the magnetic cup 400. Similarly, an attractive force between the second magnet 422 of the magnetic cup 400 and the fourth magnet of the second arm 1112 of the tool 1010 is stronger than the attractive force between the first magnet 421 and the second magnet 422 of the magnetic cup 400.

Accordingly, once the second seal is broken, the contents of the interior chamber 150 of the target capsule 100 can drain into the syringe 1020 because of the orientation of the magnetic cup assembly 900. During the recovery process, a dissolution fluid can be injected to the syringe 1020 to help wash the target capsule 100. It can be beneficial to agitate the dissolution solution during the recovery process to ensure the contents of the target capsule 100 (e.g., the contents contained in the interior chamber 150) are flushed out. Thus, in some cases, a manipulator can be used to move the tool 1010.

For example, the tool 1010 can be rotated around the syringe 1020 and/or moved up and down the syringe 1020. By moving the tool 1010, the magnetic cup assembly 900 is also moved due to the strong magnetic forces between the tool 1010 and the magnetic cup assembly 900. Thus, the magnetic cup assembly 900 can agitate the dissolution solution without needed to open the dissolution assembly 1000.

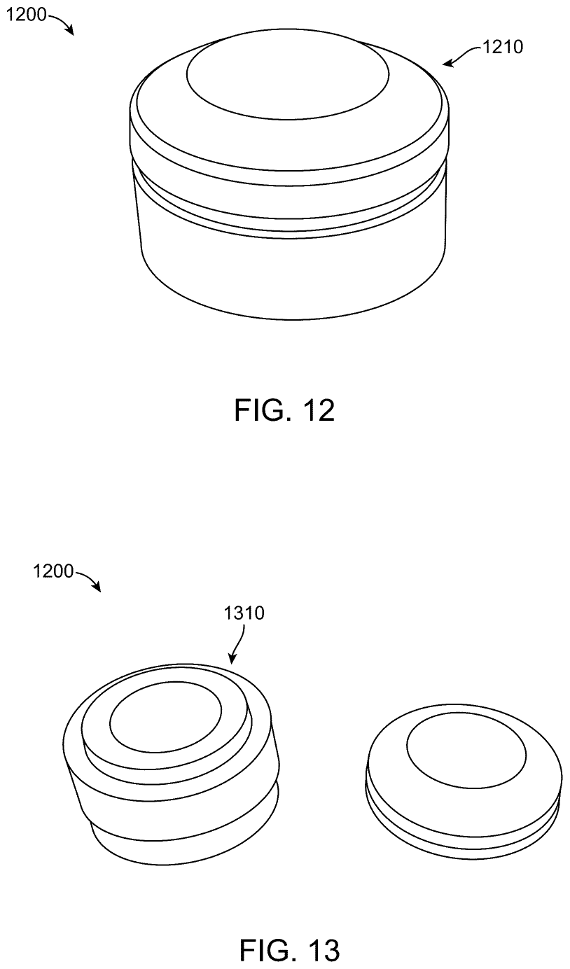

FIGS. 12 and 13 illustrate an exemplary magnetic cup assembly 1200. The magnetic cup assembly 1200 can be the magnetic cup assembly 900 described herein. Thus, the magnetic cup assembly 1200 includes a magnetic cup 1210. The magnetic cup 1210 is provided in the form of a plastic cup that can be produced through a 3D printing process. A benefit of producing the magnetic cup 1210 through a 3D printing process is that the magnetic cup 1210 can be produced quickly and cheaply. Further, as discussed herein, the target capsule may be held within the magnetic cup via a friction fit. Therefore, a benefit of the 3D printed magnetic cup 1210, is that the 3D printed magnetic cup 1210 can be made to fit the exact dimensions of a target capsule 1310.

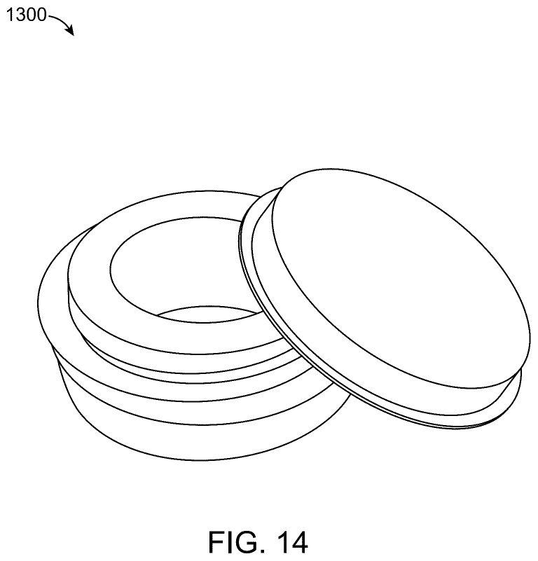

FIG. 14 shows the target capsule 1310 included in the printed magnetic cup assembly 1200 of FIG. 12. As shown, the target capsule 1310 has a similar structure to the target capsule 100 described herein. In particular, the target capsule 1310 can be provided in the form of a metal target capsule.

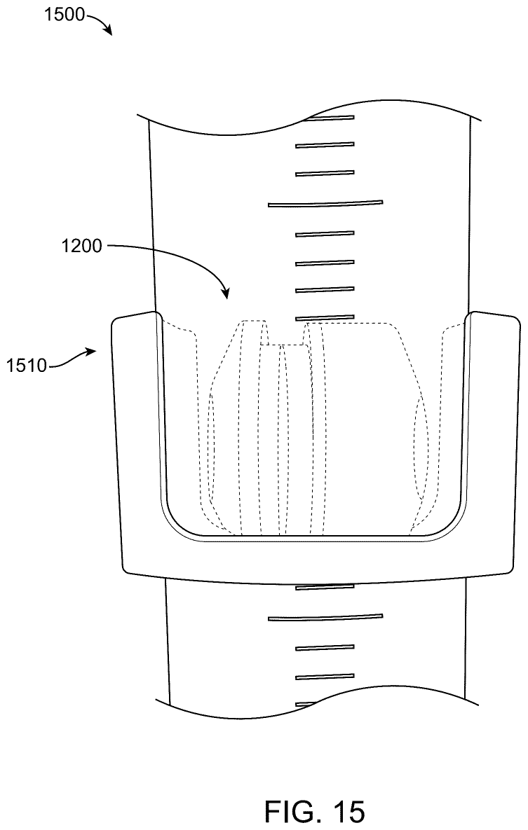

FIG. 15 shows the magnetic cup assembly 1200 of FIG. 12 within a dissolution assembly 1500 including a tool 1510 engaged with the dissolution assembly 1500. The dissolution assembly 1500 is similar to the dissolution assembly 1000 described in reference to FIGS. 10 and 11. Further, the tool 1510 is similar to the tool 1010 described in reference to FIGS. 10 and 11. Thus, as shown, the tool 1510 is capable of opening the magnetic cup assembly 1200.

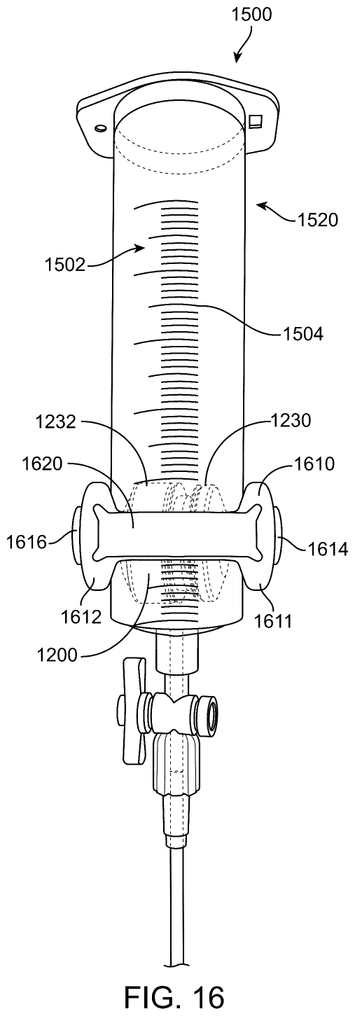

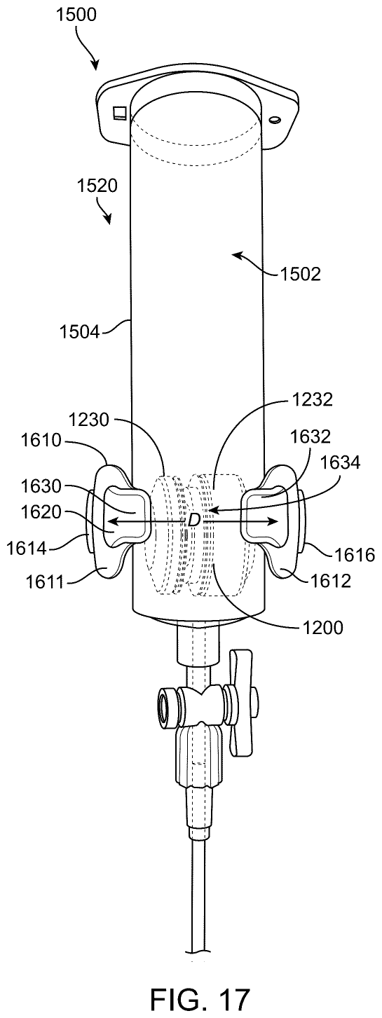

FIGS. 16 and 17 show the magnetic cup assembly 1200 and an opening tool 1610 engaged with the dissolution syringe assembly of 1500. More specifically, the magnetic cup assembly 1200 is disposed within a cavity 1502 defined by a syringe 1520 of the dissolution syringe assembly 1500. The opening tool 1610 is rotatably and slidably mounted to an outside cylindrical surface 1504 of the syringe 1520. Thus, the opening tool 1610 is rotationally and axially movable and/or repositionable around and along the syringe 1520.

Referring to FIG. 16, the opening tool 1610 includes a connection member 1620 connected to a first lobe 1611 and a second lobe 1612, which each include a first magnet 1614 and a second magnet 1616, respectively. In some embodiments, the connection member 1620 is semi-annular (e.g., shaped like a horseshoe, letter “C”, crescent, etc.). More specifically, the first lobe 1611 and the second lobe 1612 are located circumferentially along the connection member 1620 to oppose one another. Thus, the first magnet 1614 and the second magnet 1616 also oppose one another. In some embodiments, the first lobe 1611 and/or the second lobe 1612 extend axially outwardly from the connection member 1620. The first magnet 1614 and/or the second magnet 1616 are attached to the first lobe 1611 and the second lobe 1612, respectively, via adhesive, screw threads, friction fit, snaps, clips, etc. In some embodiments, the connection member 1620 is formed of a resilient and/or elastomeric material. Thus, the connection member 1620 may radially inwardly urge the first lobe 1611 and the second lobe 1612 against the syringe 1520.

Referring to FIG. 17, the connection member 1620 further includes a first retention tip 1630 and a second retention tip 1632 extending from the first lobe 1611 and the second lobe 1612, respectively. Thus, the first retention tip 1630 and the second retention tip 1632 define a radial opening 1634, which is smaller than a diameter D of the connection member 1620. Additionally, the connection member 1620 may resiliently stretch as the syringe 1520 is pushed through the radial opening 1634. Thus, the opening tool 1610 may be snapably mounted about the syringe 1520 via the radial opening 1634.

In operation, the opening tool 1610 magnetically attracts and/or interacts with the magnetic cup assembly 1200. Thus, as the opening tool 1610 rotates about and/or slides along the syringe 1520, the magnetic cup assembly 1200 follows and rotates within and/or slides along the syringe 1520. Consequently, the opening tool 1610 may be used to reposition and/or reorient the magnetic cup assembly 1200 within the syringe 1520. Further, the opening tool 1610 may magnetically attract a first portion 1230 and a second portion 1232 of the magnetic cup assembly 1200 away from one another, thus opening the magnetic cup assembly 1200 within the syringe 1520 without physical contact from the opening tool 1610.

Specific embodiments of a magnetic cup assembly have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

What is claimed is:

1. A magnetic cup for use with a target capsule, comprising:
a first cup portion including a first recess designed to retain a first magnet and at least a first portion of the target capsule; and
a second cup portion including a second recess designed to retain a second magnet and at least a second portion of the target capsule,
wherein the first magnet and the second magnet are attracted to each other through a magnetic force, thereby causing the first cup portion and the second cup portion to be drawn towards each other thereby forming the magnetic cup.

2. The magnetic cup of claim 1, wherein the first cup portion and the second cup portion are composed of a metal.

3. The magnetic cup of claim 1, wherein the first cup portion and the second cup portion are composed of a plastic.

4. The magnetic cup of claim 1, wherein the first cup portion and the second cup portion are made through a 3D printing process.

5. The magnetic cup of claim 1, wherein the first magnet is secured to the first cup portion and the second magnet is secured to the second cup portion through one or more catches.

6. The magnetic cup of claim 1, wherein the first magnet is secured to the first cup portion and the second magnet is secured to the second cup portion via an adhesive.

7. The magnetic cup of claim 1, wherein the target capsule includes a welded seal that is not covered by the magnetic cup.

8. The magnetic cup of claim 1, wherein the target capsule is designed to contain a target material for irradiation.

9. A magnetic cup assembly for use with a target capsule, comprising:
a magnetic cup including
a first cup portion including a first magnet; and
a second cup portion including a second magnet,
wherein the first magnet and the second magnet are attracted to each other through a first magnetic force, thereby causing the first cup portion and the second cup portion to be drawn towards each other and at least partially surround the target capsule; and
a tool designed to assist a user for opening the magnetic cup, the tool comprising:
a first arm including a third magnet designed to attract the first magnet through a second magnetic force greater than the first magnetic force; and
a second arm including a fourth magnet designed to attract the second magnet through a third magnetic force greater than the first magnetic force.

10. The magnetic cup assembly of claim 9, wherein the tool is designed to open the magnetic cup by overcoming the first magnetic force between the first cup portion and the second cup portion when the magnetic cup is placed in a region between the first arm and the second arm of the tool.

11. The magnetic cup assembly of claim 9, wherein:
the tool further comprises a connection member;
the first arm is connected to and extends outwardly from a first portion of the connection member, and
the second arm is connected to and extends outwardly from a second portion of the connection member, opposite the first portion.

12. The magnetic cup assembly of claim 11, wherein the connection member is provided in the shape of a ring designed to engage with a syringe included in a dissolution assembly.

13. The magnetic cup assembly of claim 12, wherein the tool is designed orient the magnetic cup in a sideways position when the magnetic cup is placed in the syringe.

14. The magnetic cup assembly of claim 12, further comprising a manipulator device designed to move the tool around the syringe, thereby moving the magnetic cup.

15. The magnetic cup assembly of claim 9, wherein an interior chamber of the target capsule can be accessed when the magnetic cup is opened.

16. A method of securing a target capsule in a closed position, comprising the steps of:
providing the target capsule, the target capsule including
a first capsule portion including a first body and a first rim extending outwardly from the first body, and
a second capsule portion including a second body and a second rim extending outwardly from the second body;
creating a first seal between the first rim and the second rim;
providing a magnetic cup, the magnetic cup including
a first cup portion including a first recess designed to retain a first magnet and the first body of the target capsule, and
a second cup portion including a second recess designed to retain a second magnet and the second body of the target capsule; and
creating a second seal between the first cup portion and the second cup portion.

17. The method of claim 16, wherein the first seal is created by welding the first rim to the second rim.

18. The method of claim 16, wherein the first seal can be broken without breaking the second seal.

19. The method of claim 16, wherein the second seal is created by drawing the first cup portion towards the second cup portion through a magnetic force between the first magnet and the second magnet.

20. The method of claim 16, wherein the first seal is created prior to creating the second seal.

21. A tool designed to open a magnetic cup, comprising:
a connection member defining a radial opening;
a first magnet mounted to the connection member; and
a second magnet mounted to the connection member.

22. The tool of claim 21, wherein the connection member is formed of a resilient material.

23. The tool of claim 21, wherein
the first magnet and the second magnet are supported by a first lobe and a second lobe, respectively, and
the connection member connects the first lobe to the second lobe.

24. The tool of claim 21, wherein the connection member is semi-annular.

25. The tool of claim 21, wherein the first magnet and the second magnet are circumferentially located along the connection member to oppose one another.

26. The tool of claim 21, wherein a first retention tip and a second retention tip of the connection member define the radial opening.

27. The tool of claim 21, wherein the radial opening is smaller than a diameter of the connection member.

28. The tool of claim 21, wherein the connection member is configured to snapably engage a cylindrical surface.
